(19) United States
(12) Patent Application Publication
(10) Pub. No.: US 2026/0142560 A1
(43) Pub. Date: May 21, 2026

(54) MULTIPLE-PHASE CONSTANT ON-TIME CONTROLLER AND POWER CONVERTER USING THE SAME

(71) Applicant: Elite Semiconductor Microelectronics Technology Inc., Hsinchu (TW)

(72) Inventors: Yao-Ren CHANG, Hsinchu (TW); Isaac Y. CHEN, Hsinchu (TW)

(21) Appl. No.: 18/950,399

(22) Filed: Nov. 18, 2024

(51) Int. Cl. H02M 1/15; H02M 1/084; H02M 3/158

(52) U.S. Cl. CPC H02M 1/15; H02M 1/084; H02M 3/1586

(57) ABSTRACT

In a power converter, a phase controller divides a full COT control signal into a master COT control signal and at least one slave COT control signal. The master COT control signal triggers a master PWM-signal generator to generate a master PWM signal accordingly, and each slave COT control signal triggers a corresponding slave PWM-signal generator to generate the slave PWM signal for a corresponding slave driver by adjusting a width of each pulse of the corresponding slave COT control signal according to a comparison between a sensed current of a master driver and a sensed current of the corresponding slave driver. Then, the master driver provides a master current output for a load device according to a master PWM signal, and each slave driver provides a slave current output for the load device according to the slave PWM signal corresponding thereto.

### BACKGROUND OF THE INVENTION

The present disclosure relates to a multiple-phase (“multi-phase” in short) constant on-time (“COT” in short) controller and a power converter. More specifically, the present disclosure relates to a multi-phase COT controller for multi-phase interleaving of a power converter, and the power converter that includes the multi-phase COT controller.

COT refers to a control scheme in which the on-time of a switch (e.g., a transistor) is kept constant, while the off-time varies depending on the load conditions. When dealing with a multi-phase power converter, i.e., a multi-phase circuit that involves multiple power stages (phases) working together, it is important to maintain the consistency of power converter at each stage to reduce ripple (i.e., current balancing), especially when the sensed current in each stage is different. In view of this, there is an urgent need in the art for a good way of multi-phase interleaving for power converters based on COT.

### SUMMARY OF THE INVENTION

To solve at least the abovementioned problem, the present disclosure provides a multiple-phase COT controller. The multiple-phase COT controller may comprise a master PWM-signal generator for a master driver, at least one slave PWM-signal generator for at least one slave driver respectively, and a phase controller. The phase controller may be electrically connected with the master PWM-signal generator and each slave PWM-signal generator and may be arranged to divide a full COT control signal into a master COT control signal and at least one slave COT control signal. The master COT control signal is arranged to trigger the master PWM-signal generator, and each slave COT control signal is arranged to trigger the corresponding slave PWM-signal generator. The master PWM-signal generator may be arranged to generate a master PWM signal according to the master COT control signal, and each slave PWM-signal generator may be arranged to generate a slave PWM signal by adjusting a width of each pulse of the corresponding slave COT control signal according to a comparison between a sensed current of the master driver and a sensed current of the corresponding slave driver.

To solve at least the abovementioned problem, the present disclosure also provides a power converter. The power converter may comprise a master driver, at least one slave driver, a master PWM-signal generator for the master driver, at least one slave PWM-signal generator for the at least one slave driver respectively, a master PWM-signal generator for the master driver electrically connected with the master driver, and a phase controller. The master driver may be arranged to provide a master current output for a load device according to a master PWM signal. The at least one slave driver may be electrically connected with the master driver, and each slave driver may be arranged to provide a slave current output for the load device according to a slave PWM signal corresponding thereto. The phase controller may be electrically connected with the master driver, the master PWM-signal generator, and each slave PWM-signal generator, and may be arranged to divide a full COT control signal into a master COT control signal and at least one slave COT control signal. The master COT control signal is arranged to trigger the master PWM-signal generator, and each slave COT control signal is arranged to trigger the corresponding slave PWM-signal generator. The master PWM-signal generator may be electrically connected with the master driver and may be arranged to generate the master PWM signal according to the master COT control signal, and each slave PWM-signal generator may be arranged to generate the slave PWM signal corresponding to one of the at least one slave driver by adjusting a width of each pulse of the corresponding slave COT control signal according to a comparison between a sensed current of the master driver and a sensed current of the corresponding slave driver.

The present disclosure balances the current outputs provided among multiple phases/channels (i.e., the master driver and the at least one slave driver) via adjusting the width of each pulse in their corresponding COT control signals according to the comparison between the sensed currents of the master driver and each slave driver. This maintains the COT characteristic at each phase/channel whilst providing current balancing feature at the same time. The present disclosure also provides improved performance in terms of reduced ripple, better thermal management, and higher efficiency.

This summary overall describes the core concept of the present invention and covers the problem to be solved, the means to solve the problem and the effect of the present invention to provide a basic understanding of the present invention by those of ordinary skill in the art. However, it shall be appreciated that, this summary is not intended to encompass all embodiments of the present invention but is provided only to present the core concept of the present invention in a simple form and as an introduction to the following detailed description. The detailed technology and preferred embodiments implemented for the subject invention are described in the following paragraphs accompanying the appended drawings for people having ordinary skills in the art to well appreciate the features of the claimed invention.

### BRIEF DESCRIPTION OF DRAWINGS

The drawings are provided for describing the embodiments of the present disclosure, wherein:

FIG. 1 depicts a schematic view of a power converter and a multi-phase COT controller therein according to one or more embodiments of the present disclosure;

FIG. 2 depicts a more detailed schematic view of the power converter and the multi-phase COT controller in FIG. 1;

FIG. 3 depicts a schematic view of the signals transmitted in the power converter according to one or more embodiments of the present disclosure; and

FIG. 4 depicts a slave PWM-signal generator and the corresponding parts of the phase controller that controls the slave PWM-signal generator according to one or more embodiments of the present disclosure.

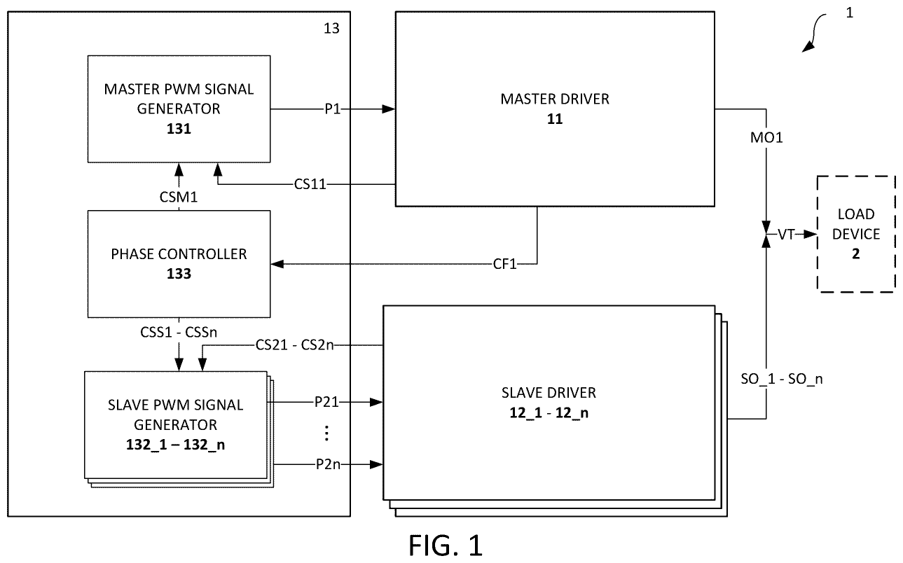

The contents shown in FIGS. 1-4 are provided only for helpfully illustrating the embodiments of the present disclosure, instead of limiting the scope of the present disclosure.

### DETAILED DESCRIPTION OF THE INVENTION

The embodiments disclosed below are not intended to limit the claimed invention to any specific environment, applications, structures, processes, or situations. In the attached drawings, elements which are not directly related to the claimed invention are omitted from depiction. Dimensions and dimensional relationships among individual elements in the attached drawings are only exemplary examples and are not intended to limit the claimed invention. Unless stated particularly, same element numerals may correspond to same elements in the following description without inconsistency with the claimed invention.

The terminology used herein is for the purpose of describing the embodiments only and is not intended to limit the claimed invention. The singular forms “a” and “an” are intended to include the plural forms as well unless the context clearly indicates otherwise. The terms “comprises,” “comprising,” “includes,” “including,” etc., specify the presence of the stated features, integers, steps, operations, elements, and/or components, but do not preclude the presence or addition of one or more other features, integers, steps, operations, elements, components, and/or groups thereof. The term “and/or” includes any and all combinations of one or more of the associated listed items. Although the terms “first,” “second,” “third,” etc., may be used herein to describe various elements, these elements should not be limited by these terms. These terms are merely used to distinguish one element from another element. Thus, for example, a first element described below could also be termed a second element, without departing from the spirit and scope of the claimed invention.

Please refer to FIG. 1, a first embodiment of the present disclosure may be a power converter 1. The power converter 1 may basically comprise a master driver 11, at least one slave driver (referred to as “slave driver(s) 12_1-12_n” hereinafter), and a multi-phase COT controller 13 electrically connected with the master circuit 11 and the at least one slave circuit. Each of the slave driver(s) 12_1-12_n may be electrically connected with the master driver 11.

The power converter 1 may be arranged to provide a current output Vt for a load device 2. The current output VT may consist of a master current output MO1 provided by the master driver 11 and at least one slave current output provided by the slave driver(s) 12_1-12_n (referred to as “slave current output(s) SO_1-SO_n” hereinafter). To provide such a current output, the master driver 11, in general, may provide a full COT control signal CF1 for the multi-phase COT controller 13, and the multi-phase COT controller 13 may process the full COT control signal CF1 to provide a master PWM signal P1 for the master driver 11 and provide at least one slave PWM signal (referred to “slave PWM signal(s) P21-P2n” hereinafter) for the slave driver(s) 12_1-12_n, respectively. The master driver 11 may then be arranged to provide the master current output MO1 for the load device 2 according to a master PWM signal P1, whereas the slave driver(s) 12_1-12_n, similarly, may be arranged to provide the slave current output(s) SO_1-SO_n for the load device 2 according to the corresponding slave PWM signal(s) P21-P2n, respectively.

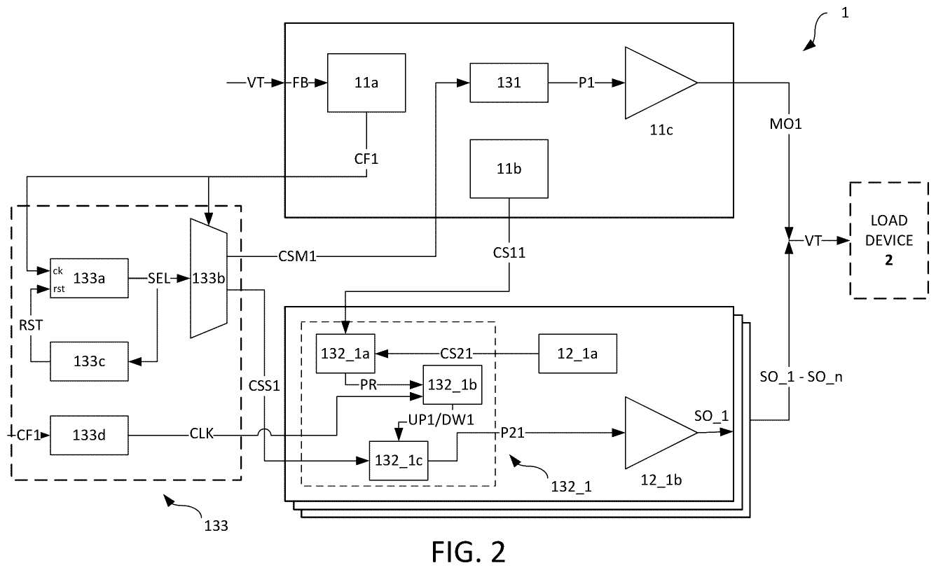

Please refer to FIG. 1 and FIG. 2 together. The master driver 11 may comprise a COT controller 11a, a master current sensor 11b, and a PWM driver 11c. Each of the slave driver(s) 12_1-12_n, taking the slave driver 12_1 as an example, may comprise a slave current sensor 12_1a and a PWM driver 12_1b. As to the multi-phase COT controller 13, it may comprise a master PWM-signal generator 131, at least one slave PWM-signal generator (referred to as “slave PWM-signal generator(s) 132_1-132_n” hereinafter), and a phase controller 133. The slave PWM-signal generator(s) 132_1-132_ncorresponds to the slave drivers 12_1-12_n, respectively.

Each of the slave PWM-signal generator(s) 132_1-132_n, taking the slave PWM-signal generator 132_1 as an example, may comprise a comparator 132_1a, an up-down counter 132_1b, and a pulse-width re-generator 132_1c.

The phase controller 133 may basically comprise a counter 133a, a demultiplexer 133b, and a reset-signal generator 133c. The counter 133a may be electrically connected with the COT controller 11a and the demultiplexer 133b. In some ways of implementation, the phase controller 133 may further comprise another counter 133d electrically connected with the COT controller 11a and each up/down counter in the slave PWM-signal generator(s) 132_1-132_n.

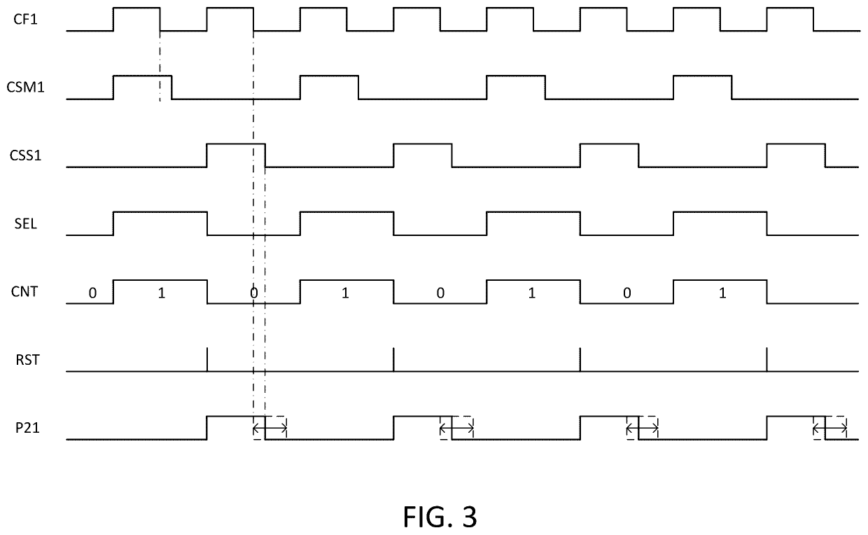

Please refer to FIG. 3 with the assistance of FIG. 1 and FIG. 2. FIG. 3 illustrates a schematic view of the signals under the circumstance that the power converter comprises one master driver and one slave driver. This is simply for the ease of describing the transitions among the master drive and the slave driver as well as the corresponding signals, rather than a limitation of the number of drivers that the power converter 1 can have.

The COT controller 11a may be arranged to generate the full COT control signal CF1 that may originally be used to control a PWM-signal generator of a single-phase power converter for generating PWM signals. As demonstrated in FIG. 3, the full COT control signal CF1 may comprise a series of pulses having the same pulse width, which is consistent with the concept of COT.

However, for COT control of a multi-phase power converter such as the power converter 1, the full COT control signal CF1 may be divided, by the phase controller 133, into a plurality of COT control signals corresponding to the master PWM-signal generator 131 and the slave PWM-signal generator(s) 132_1-132_n, respectively. Said plurality of COT control signals may be a master COT control signal CSM1 and at least one slave COT control signal (referred to as “slave COT control signal(s) CSS1-CSSn” hereinafter).

In general, the master COT control signal CSM1 may be arranged to trigger the master PWM-signal generator 131 and the slave COT control signal(s) CSS1-CSSn may be arranged to trigger the corresponding slave PWM-signal generator(s) 132_1-132_n.

In some ways of implementation, the COT controller 11a may accept the current output VT of the power converter 1 as a feedback signal FB and generate/adjust the full COT control signal CF1 according to the feedback signal FB.

To divide the full COT control signal CF1 into the plurality of COT control signals, the COT controller 11a may be electrically connected with the counter 133a and the demultiplexer 133b, and the full COT control signal CF1 may be supplied to the counter 133a and the demultiplexer 133b. The counter 133a may be arranged to generate a selection signal SEL based on the full COT control signal CF1 as a clock signal. The selection signal SEL may indicate a series of numbers for selecting phases, one at a time. The numbers may be, for example but not limited to binary numbers, decimal numbers, hexadecimal numbers, etc. In the example demonstrated in FIG. 3, the selection signal SEL indicates binary numbers “0” and “1”.

The signal CNT shown in FIG. 3 represents the counting of the selection signal SEL, wherein “0” represents the master phase and “1” presents the slave phase. In some other ways of implementation that the selection signal indicates, e.g., binary numbers from “00” to “11”, the counted number “00” may represent the master phase and the counted numbers “01”, “10” and “11” may represent three slave phases corresponding to three slave drivers, respectively. The counting of the selection signal SEL may begin at a number corresponding to the master phase, e.g., “0” in the case shown in FIG. 3, meaning that the master driver 11 may operate prior to the slave driver(s) 12_1-12_n.

The demultiplexer 133b may be electrically connected with the counter 133a, the master PWM-signal generator 131, and the slave PWM-signal generator(s) 132_1-132_n, and may generate the master COT control signal CSM1 and the slave COT control signal CSS1 based on the full COT control signal CF1 and according to the selection signal SEL. The master COT control signal CSM1 may then be supplied to the master PWM-signal generator 131, and the slave COT control signal(s) (e.g., the slave COT control signal CSS1) may be supplied to the corresponding slave PWM-signal generator (e.g., the slave PWM-signal generator 132_1c), such that they generate their PWM signals accordingly. In some ways of implementation, the pulses in the master COT control signal CSM1 and the slave COT control signal(s) CSS1-CSSn may have the same pulse width as the pulses in the full COT control signal CF1 does.

The reset-signal generator 133c may be electrically connected with the counter 133a and may generate a reset signal RST for the counter 133a to switch back to the master phase from the last slave phase.

Each comparator in a slave PWM-signal generator may be electrically connected with the master current sensor 11b and the slave current sensor belonging to the same slave PWM-signal generator. The master current sensor 11b may be arranged to provide a sensed current CS11 of the master driver 11, and each slave current sensor may be arranged to provide the sensed current of the corresponding slave driver for the corresponding slave PWM-signal generator. Therefore, each comparator in a slave PWM-signal generator may compare the sensed current in the corresponding slave driver with the sensed current CS11 in the master driver 11 and provide a comparison result for the corresponding up-down counter.

Each up-down counter may be electrically connected with the corresponding comparator to receive the comparison result. Each up-down counter may also be electrically connected with the corresponding pulse-width re-generator belonging to the same slave PWM-signal generator to provide a pulse-width adjusting information therefor. Also, each up-down counter may be electrically connected with the other counter 133d of the phase controller 133 to receive a clock signal CLK (not shown in FIG. 3) from the counter 133d. The clock signal CLK may be provided by the counter 133d based on the full COT control signal CF1.

Each pulse-width re-generator may be electrically connected with the demultiplexer 133b to receive the corresponding slave COT control signal CSS1 and may adjust the width of each pulse in the received slave COT control signal CSS1 according to the pulse-width adjusting information. The pulse-width adjusting information may comprise a pulse-width enlarging signal when the sensed current of the corresponding slave driver is weaker than the sensed current CS11 of the master driver 11, meaning that this specific slave phase needs longer on-time for the purpose of current balancing among the phases. On the contrary, the pulse-width adjusting information may comprise a pulse-width reducing signal when the sensed current of the corresponding slave driver is stronger than the sensed current CS11 of the master driver 11, meaning that this specific phase may have a shorter on-time.

In some ways of implementation, the pulse-width adjusting information may further comprise one or more instructions for operating each pulse-width re-generator.

Each adjusted slave COT control signal(s) may be output by the corresponding pulse-width re-generator as a slave PWM signal to the corresponding PWM driver. Each PWM driver in a slave driver may be electrically connected with the corresponding pulse-width re-generator to receive the slave PWM signal and provide the corresponding slave current output for the load device 2 according to the slave PWM signal received.

In some embodiments, other than enlarging or reducing the width of each pulse in the corresponding slave COT control signal, each pulse-width re-generator may keep the current pulse width of the corresponding slave COT control signal when the sensed current of the corresponding slave driver is equal to the sensed current CS11 of the master driver 11.

The slave current sensors in the slave drivers 12_1-12_n, as demonstrated in FIG. 1, may provide sensed currents CS21-CS2n for the corresponding slave PWM-signal generators 132_1-132_n, respectively. However, only the slave driver 12_1 and its corresponding slave PWM-signal generator 132_1 are taken herein as an example, and a person having ordinary skills in the art can understand the similar ways of operation of other slave drivers and their corresponding slave PWM-signal generators in accordance with the following descriptions regarding the slave driver 12_1 and its corresponding slave PWM-signal generator 132_1. As demonstrated in FIG. 2, The comparator 132_1a may first receive the sensed current CS11 from the master current sensor 11b and receive a sensed current CS21 from the slave current sensor 12_1a. The comparator 132_1a may then compare the sensed current CS21 with the sensed current CS11 and provide a comparison result PR for the up-down counter 132_1b.

The up-down counter 132_1b may generate a pulse-width enlarging signal UP1 when the comparison result PR indicates that the sensed current CS21 of the slave driver 12_1 is weaker than the sensed current CS11 of the master driver 11. On the contrary, the up-down counter 132_1b may generate a pulse-width reducing signal DW1 when the comparison result PR indicates that the sensed current CS21 of the slave driver 12_1 is stronger than the sensed current CS11 of the master driver 11.

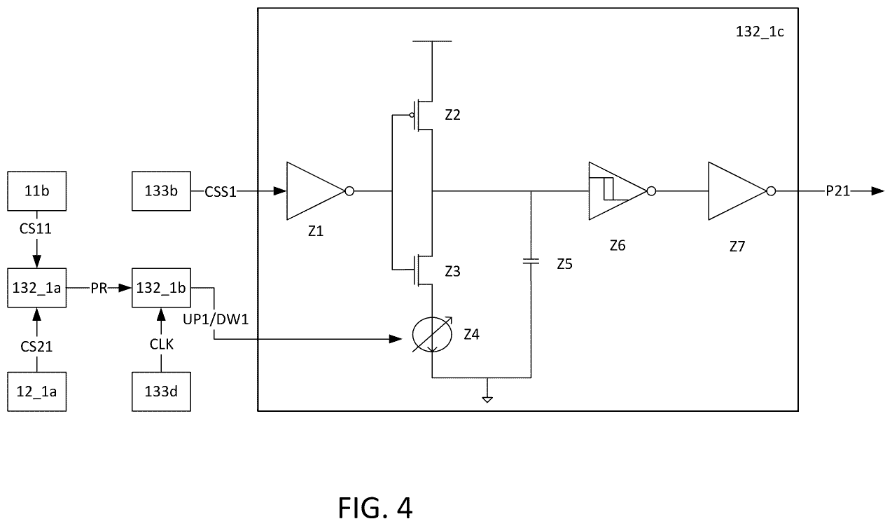

The pulse-width re-generator 132_1c may adjust the width of each pulse of the slave COT control signal CSS1 according to the pulse-width enlarging signal UP1 or the pulse-width reducing signal DW1. Please refer to FIG. 4 with FIGS. 1-3 in assistance, it demonstrates a schematic view of the pulse-width re-generator 132_1c. The pulse-width re-generator 132_1c, in some ways of implementation, may comprise an inverter Z1, a PMOS transistor Z2, an NMOS transistor Z3, a power source Z4, a capacitor Z5, an inverting Schmitt trigger Z6, and another inverter Z7. The inverter Z1 may be coupled with the demultiplexer 133b to receive the slave COT control signal CSS1. The gates of the transistors Z2 and Z3 may be electrically connected with each other and with the output of the inverter Z1. The power source Z4 may be coupled between the NMOS transistor Z3 and the ground. The pulse-width enlarging signal UP1 or the pulse-width reducing signal DW1 may be provided for controlling the power source Z4 such that the width of each pulse of the input slave COT control signal CSS1 is adjusted.

The drain of the PMOS transistor Z2 and the source of the NMOS Z3 may be coupled with each other as well as the capacitor Z5 and the input of the Inverting Schmitt trigger Z6. The inverter Z7 may accept the output of the Inverting Schmitt trigger Z6 and finally output the slave PWM signal P21.

The adjusted slave COT control signal CSS1 may be output by the pulse-width re-generator 132_1c as the slave PWM signal P21 to the corresponding PWM driver 12_1b. The PWM driver 12_1b may receive the slave PWM signal P21 and provide the corresponding slave current output SO_1 for the load device 2 according to the slave PWM signal P21. The rest of the slave current output(s) may be provided in the same way as in the master driver 11 and the slave PWM-signal generator 132_1.

As to the master driver 11, the master PWM-signal generator 131 may have a similar hardware to the pulse-width re-generator 132_1c since they both are used to provide PWM signals. The master PWM-signal generator 131 may generate the master PWM signal P1 for the PWM driver 11c according to the master COT control signal CSM1, such that the PWM driver 11c outputs the master current output MO1 according to the master PWM signal P1.

In some ways of implementation, as illustrated in FIG. 3, the master PWM-signal generator 131 may enlarge the width of each pulse of the master COT control signal CSM1 before providing it for the PWM driver 11c, as demonstrated by the dotted line on the first pulse of the master COT control signal CSM1. Each pulse-width re-generator (e.g., the pulse-width re-generator 132_1c) may also enlarge the width of each pulse of the corresponding slave COT control signal first, and then perform the adjustments as indicated by the pulse-adjusting information for the corresponding slave COT control signal, as demonstrated by the first dotted line on the first pulse of the slave COT control signal CSS1. The width of each pulse of each slave COT control signal may be enlarged to the same pulse width of the master COT control signal CSM1 by each corresponding slave pulse-width re-generator.

In some ways of implementation, the width of each pulse of each slave COT control signal, when reduced, may be no shorter than the width of each pulse of the master COT control signal CSM1.

A second embodiment of the present disclosure may be the multi-phase COT controller 13 as described above. The multi-phase COT controller 13, in some ways of implementation, may be a standalone device that cooperates with the master driver 11 and the slave driver(s) 12_1-12_n, as demonstrated in FIG. 1. In some other ways of implementation, the master PWM-signal generator 131 may be integrated with the master driver 11, whereas each of the slave PWM-signal generator(s) 132_1-132_n may be integrated with the corresponding slave driver in the slave driver(s) 12_1-12_n, as demonstrated in FIG. 2.

According to the above, the multi-phase COT controller 13 of the present disclosure provides an excellent way for multi-phase interleaving of the power converter 1. The width of each pulse in the at least one slave COT control signal is adjusted according to the comparison of sensed currents of the master driver 11 and each slave driver, which further affects the on-time in each slave phase. The current output(s) in the slave phase(s) can therefore be adjusted to reach the current output of the master phase. This overall provides a current balancing mechanism for the power converter 1 whilst still maintaining the COT characteristics in all phases. In addition, the current balancing mechanism aims on adjusting the pulse widths for the slave driver(s) rather than all drivers in the power converter 1. This provides a more efficient way of multi-phase current balancing.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A multiple-phase COT controller, comprising:
a master PWM-signal generator for a master driver;
at least one slave PWM-signal generator for at least one slave driver respectively; and
a phase controller, being electrically connected with the master PWM-signal generator and each slave PWM-signal generator, and being arranged to divide a full COT control signal into a master COT control signal and at least one slave COT control signal, wherein the master COT control signal is arranged to trigger the master PWM-signal generator and each slave COT control signal is arranged to trigger the corresponding slave PWM-signal generator;
wherein:
the master PWM-signal generator is arranged to generate a master PWM signal according to the master COT control signal; and
each slave PWM-signal generator is arranged to generate a slave PWM signal by adjusting a width of each pulse of the corresponding slave COT control signal according to a comparison between a sensed current of the master driver and a sensed current of the corresponding slave driver.

2. The multiple-phase COT controller of claim 1, wherein the master PWM-signal generator generates the master PWM signal by enlarging a width of each pulse of the master COT control signal.

3. The multiple-phase COT controller of claim 1, wherein each of the slave PWM-signal generator adjusts the corresponding slave COT control signal by enlarging a width of each pulse of the slave COT control signal when the sensed current of the corresponding slave driver is weaker than the sensed current of the master driver.

4. The multiple-phase COT controller of claim 1, wherein each of the slave PWM-signal generator adjusts the corresponding slave COT control signal by reducing the width of each pulse of the slave COT control signal when the sensed current of the corresponding slave driver is stronger than the sensed current of the master driver.

5. The multiple-phase COT controller of claim 4 wherein the width of each pulse of the slave COT control signal is no shorter than a width of each pulse of the full COT control signal.

6. The multiple-phase COT controller of claim 3, wherein each of the slave PWM-signal generator adjusts the corresponding slave COT control signal by first enlarging the width of each pulse of the slave COT control signal, and then enlarging the width of each pulse of the slave COT control signal when the sensed current of the corresponding slave driver is weaker than the sensed current of the master driver.

7. The multiple-phase COT controller of claim 4, wherein each of the slave PWM-signal generator adjusts the corresponding slave COT control signal by first enlarging the width of each pulse of the slave COT control signal, and then reducing the width of each pulse of the slave COT control signal when the sensed current of the corresponding slave driver is stronger than the sensed current of the master driver.

8. The multiple-phase COT controller of claim 7, wherein the width of each pulse of the slave COT control signal is no shorter than a width of each pulse of the full COT control signal.

9. The multiple-phase COT controller of claim 1, wherein the phase controller comprises:
a counter, being arranged to generate a selection signal based on the full COT control signal; and
a demultiplexer, being electrically connected with the counter and arranged to generate the master COT control signal and the at least one slave COT control signal according to the selection signal and the full COT control signal.

10. The multiple-phase COT controller of claim 9, wherein the selection signal indicates that the master COT control signal is output prior to the at least one slave COT control signal by the demultiplexer.

11. The multiple-phase COT controller of claim 9, wherein the phase controller further comprises a reset-signal generator electrically connected with the counter, the reset-signal generator being arranged to generate a reset signal for the counter.

12. The multiple-phase COT controller of claim 3, wherein each of the at least one slave PWM-signal generator comprises:
a comparator, arranged to compare the sensed current of the slave driver corresponding to the slave PWM-signal generator with the sensed current of the master driver;
an up-down counter, being electrically connected with the comparator and arranged to generate a pulse-width enlarging signal when the sensed current of the slave driver is weaker than the sensed current of the master driver; and
a pulse-width re-generator, being electrically connected with the up-down counter and the phase controller and arranged to enlarge the width of each pulse of the slave COT control signal as the slave PWM signal in response to the pulse-width enlarging signal.

13. The multiple-phase COT controller of claim 4, wherein each of the at least one slave PWM-signal generator comprises:
a comparator, arranged to compare the sensed current of the slave driver corresponding to the slave PWM-signal generator with the sensed current of the master driver;
an up-down counter, being electrically connected with the comparator and arranged to generate a pulse-width reducing signal when the sensed current of the slave driver is stronger than the sensed current of the master driver; and
a pulse-width re-generator, being electrically connected with the up-down counter and the phase controller and arranged to reduce the width of each pulse of the slave COT control signal as the slave PWM signal in response to the pulse-width reducing signal.

14. The multiple-phase COT controller of claim 1, wherein the full COT control signal is generated by the master driver, and the phase controller is further arranged to receive the full COT control signal from the master driver.

15. A power converter, comprising:
a master driver, being arranged to provide a master current output for a load device according to a master PWM signal;
at least one slave driver, being electrically connected with the master driver, wherein each slave driver is arranged to provide a slave current output for the load device according to a slave PWM signal corresponding thereto;
a master PWM-signal generator for the master driver, being electrically connected with the master driver;
at least one slave PWM-signal generator for the at least one slave driver respectively; and
a phase controller, being electrically connected with the master driver, the master PWM-signal generator, and each slave PWM-signal generator, and being arranged to divide a full COT control signal into a master COT control signal and at least one slave COT control signal, wherein the master COT control signal is arranged to trigger the master PWM-signal generator and each slave COT control signal is arranged to trigger the corresponding slave PWM-signal generator;
wherein:
the master PWM-signal generator is arranged to generate the master PWM signal according to the master COT control signal; and
each slave PWM-signal generator is arranged to generate the slave PWM signal corresponding to one of the at least one slave driver by adjusting a width of each pulse of the corresponding slave COT control signal according to a comparison between a sensed current of the master driver and a sensed current of the corresponding slave driver.

16. The power converter of claim 15, wherein the master PWM-signal generator generates the master PWM signal by enlarging a width of each pulse of the master COT control signal.

17. The power converter of claim 15, wherein each of the slave PWM-signal generator adjusts the corresponding slave COT control signal by enlarging a width of each pulse of the slave COT control signal when the sensed current of the corresponding slave driver is weaker than the sensed current of the master driver.

18. The power converter of claim 15, wherein each of the slave PWM-signal generator adjusts the corresponding slave COT control signal by reducing the width of each pulse of the slave COT control signal when the sensed current of the corresponding slave driver is stronger than the sensed current of the master driver.

19. The power converter of claim 18, wherein the width of each pulse of the slave COT control signal is no shorter than a width of each pulse of the full COT control signal.

20. The power converter of claim 17, wherein each of the slave PWM-signal generator adjusts the corresponding slave COT control signal by first enlarging the width of each pulse of the slave COT control signal, and then enlarging the width of each pulse of the slave COT control signal when the sensed current of the corresponding slave driver is weaker than the sensed current of the master drive.

21. The power converter of claim 18, wherein each of the slave PWM-signal generator adjusts the corresponding slave COT control signal by first enlarging the width of each pulse of the slave COT control signal, and then reducing the width of each pulse of the slave COT control signal when the sensed current of the corresponding slave driver is stronger than the sensed current of the master driver.

22. The power converter of claim 21, wherein the width of each pulse of the slave COT control signal is no shorter than a width of each pulse of the full COT control signal.

23. The power converter of claim 15, wherein the phase controller comprises:
a counter, being arranged to generate a selection signal based on the full COT control signal; and
a demultiplexer, being electrically connected with the counter and arranged to generate the master COT control signal and the at least one slave COT control signal according to the selection signal and the full COT control signal.

24. The power converter of claim 23, wherein the selection signal indicates that the master COT control signal is output prior to the at least one slave COT control signal by the demultiplexer.

25. The power converter of claim 23, wherein the phase controller further comprises a reset-signal generator electrically connected with the counter, the reset-signal generator being arranged to generate a reset signal for the counter.

26. The power converter of claim 17, wherein each of the at least one slave PWM-signal generator comprises:
a comparator, being arranged to compare the sensed current of the slave driver corresponding to the slave PWM-signal generator with the sensed current of the master driver;
an up-down counter, being electrically connected with the comparator and arranged to generate a pulse-width enlarging signal when the sensed current of the slave driver is weaker than the sensed current of the master driver; and
a pulse-width re-generator, being electrically connected with the up-down counter and the phase controller and arranged to enlarge the width of each pulse of the slave COT control signal as the slave PWM signal in response to the pulse-width enlarging signal.

27. The power converter of claim 18, wherein each of the at least one slave PWM-signal generator comprises:
a comparator, being arranged to compare the sensed current of the slave driver corresponding to the slave PWM-signal generator with the sensed current of the master driver;
an up-down counter, being electrically connected with the comparator and arranged to generate a pulse-width reducing signal when the sensed current of the slave driver is stronger than the sensed current of the master driver; and
a pulse-width re-generator, being electrically connected with the up-down counter and the phase controller and arranged to reduce the width of each pulse of the slave COT control signal as the slave PWM signal in response to the pulse-width reducing signal.

28. The power converter of claim 15, wherein the full COT control signal is generated by the master driver, and the phase controller is further arranged to receive the full COT control signal from the master driver.

29. The power converter of claim 15, wherein the master PWM-signal generator is integrated with the master driver.

30. The power converter of claim 15, wherein the master driver comprises:
a COT controller, being electrically connected with the phase controller, and being arranged to generate the full COT control signal according to a total current output of the power converter, wherein the total current output is jointly formed by the master current output and the slave current output;
a master current sensor, being electrically connected with the at least one slave PWM-signal generator, and being arranged to provide the sensed current of the master driver for the at least one slave PWM-signal generator; and
a PWM driver, being electrically connected with the master PWM-signal generator and arranged to provide the master current output according to the master PWM signal.

31. The power converter of claim 15, wherein each of the slave driver comprises:
a slave current sensor, being electrically connected with the slave PWM-signal generator and arranged to provide the sensed current of the slave driver for the slave PWM-signal generator; and
a PWM driver, being electrically connected with the slave PWM-signal generator and arranged to provide the slave current output according to the slave PWM signal.
